(19) United States
(12) Patent Application Publication
(10) Pub. No.: US 2021/0229268 A1
(43) Pub. Date: Jul. 29, 2021

(54) Gear Device And Robot

(71) Applicant: Seiko Epson Corporation, Toyko (JP)

(72) Inventor: Yoichi NODA, Fujimi (JP)

(21) Appl. No.: 17/158,127

(22) Filed: Jan. 26, 2021

(30) Foreign Application Priority Data
Jan. 27, 2020 (JP) 2020-010600

(51) Int. Cl. B25J 9/10

(52) U.S. Cl. CPC B25J 9/102; B25J 17/00; B25J 9/109; B25J 9/108

(57) ABSTRACT

A gear device includes an internal gear, an external gear having flexibility configured to partially mesh with the internal gear and relatively rotate around a rotation axis with respect to the internal gear, a bearing disposed at an inner side of the external gear, and a cam section having an elliptical shape disposed at an inner side of the bearing and configured to move a meshing position of the internal gear and the external gear in a circumferential direction around the rotation axis. The bearing is deformed in an elliptical shape by the cam section and includes a plurality of balls disposed side by side in the circumferential direction and a holder including a plurality of partition walls disposed alternately with the balls in the circumferential direction and holding the balls. A gap is provided between the ball located on a major axis of the bearing and the partition wall adjacent to the ball in the circumferential direction. The ball located on a minor axis of the bearing is in contact with each of the partition walls adjacent to the ball at both sides in the circumferential direction.

The present application is based on, and claims priority from JP Application Serial Number 2020-010600, filed Jan. 27, 2020, the disclosure of which is hereby incorporated by reference herein in its entirety.

### BACKGROUND

### 1. Technical Field

The present disclosure relates to a gear device and a robot.

### 2. Related Art

In a robot including a robot arm, for example, a joint section of the robot arm is driven by a motor. In general, rotation of the motor is decelerated by a gear device. As such a gear device, for example, a wave motion gear device disclosed in JP-A-2016-121719 (Patent Literature 1) has been known.

The wave motion gear device described in Patent Literature 1 includes an annular internal gear, an external gear disposed at the inner side of the internal gear, and a wave motion generator having an elliptical contour fit in the inner side of the external gear. The wave motion generator includes an elliptical cam and a bearing fit in the outer circumference of the cam and deformed from a circular shape into an elliptical shape. The bearing is a ball bearing and includes an inner ring, an outer ring, and a plurality of balls disposed between the inner ring and the outer ring.

The external gear is bent in an elliptical shape by the wave motion generator and meshed with the internal gear in an elliptical portion in a major axis direction. The internal gear and the external gear have a number of teeth difference. When the wave motion generator is rotated, a meshing position of the internal gear and the external gear moves in the circumferential direction and the internal gear and the external relatively rotate according to the number of teeth difference between the internal gear and the external gear.

In such a wave motion gear device, as explained above, the bearing is deformed from the circular shape into the elliptical shape by the cam. Accordingly, in the major axis direction of the bearing, the interval between the inner ring and the outer ring is narrowed. Since the balls are sandwiched between the inner ring and the outer ring, a compression force in the radial direction is applied to the balls and the balls less easily move. Therefore, the interval between the balls adjacent to each other less easily changes. On the other hand, in the minor axis direction of the bearing, the compression force in the radial direction is less easily applied to the balls compared with the major axis direction and the balls easily move. Therefore, the interval between the balls adjacent to each other easily changes.

Therefore, in such a wave motion gear device, when the interval between the balls adjacent to each other in the minor axis direction deviates from a proper value and the deviating inappropriate interval is maintained in the major axis direction as well, an unintended excessive compression force is easily applied to the bearing. It is likely that performance deterioration of and damage to the wave motion gear device are caused.

### SUMMARY

A gear device according to an embodiment includes: an internal gear; an external gear having flexibility configured to partially mesh with the internal gear and relatively rotate around a rotation axis with respect to the internal gear; a bearing disposed at an inner side of the external gear; and a cam section having an elliptical shape disposed at an inner side of the bearing and configured to move a meshing position of the internal gear and the external gear in a circumferential direction around the rotation axis. The bearing is deformed in an elliptical shape by the cam section and includes a plurality of balls disposed side by side in the circumferential direction and a holder including a plurality of partition walls disposed alternately with the balls in the circumferential direction and holding the balls. A gap is provided between the ball located on a major axis of the bearing and the partition wall adjacent to the ball in the circumferential direction. The ball located on a minor axis of the bearing is in contact with each of the partition walls adjacent to the ball on both sides in the circumferential direction.

A robot according to an embodiment includes: a first member; a second member configured to turn with respect to the first member; and the gear device described above configured to transmit a driving force for turning the second member with respect to the first member from the first member to the second member or from the second member to the first member.

### BRIEF DESCRIPTION OF THE DRAWINGS

FIG. 1 is a side view showing a schematic configuration of a robot according to an embodiment of the present disclosure.

FIG. 2 is an exploded perspective view showing a gear device according to a preferred embodiment of the present disclosure.

FIG. 3 is a front view of the gear device shown in FIG. 2.

FIG. 4 is a diagram schematically showing states of the outer circumferential surface of a wave motion generator and an inner circumferential surface of an external gear in a natural state in the gear device shown in FIG. 2.

FIG. 5 is a front view of the gear device shown in FIG. 2 in which the number of balls of a bearing is set to an even number.

FIG. 6 is a front view of the bearing included in the gear device shown in FIG. 2.

FIG. 7 is a partially enlarged front view showing a state of the ball located on the major axis of the bearing shown in FIG. 6.

FIG. 8 is a partially enlarged front view showing a state of the ball located on the minor axis of the bearing shown in FIG. 6.

FIG. 9 is a partially enlarged front view showing a modification of a partition wall included in the bearing shown in FIG. 6.

FIG. 10 is a partially enlarged front view showing a modification of the partition wall included in the bearing shown in FIG. 6.

FIG. 11 is a partially enlarged front view showing a modification of the partition wall included in the bearing shown in FIG. 6.

FIG. 12 is a sectional view schematically showing the gear device shown in FIG. 2.

FIG. 13 is a diagram showing a track of the ball included in the bearing.

FIG. 14 is a diagram showing a track of the ball included in the bearing.

FIG. 15 is a sectional view from the radial direction of the partition wall included in the gear device shown in FIG. 6.

FIG. 16 is a sectional view from the radial direction of the partition wall included in the gear device shown in FIG. 6.

FIG. 17 is a partially enlarged front view showing a bearing included in a gear device according to a second embodiment.

### DESCRIPTION OF EXEMPLARY EMBODIMENTS

A gear device and a robot according to the present disclosure are explained in detail below based on embodiments shown in the accompanying drawings.

### 1. Robot

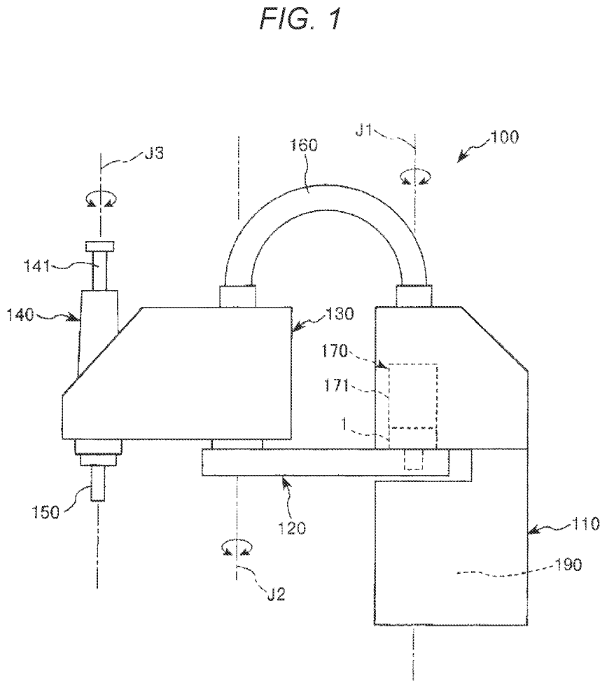

FIG. 1 is a side view showing a schematic configuration of a robot according to an embodiment of the present disclosure. In the following explanation, for convenience of explanation, the upper side in FIG. 1 is referred to as “upper” as well and the lower side in FIG. 1 is referred to as “lower” as well. A base side in FIG. 1 is referred to as “proximal end side” as well and the opposite side of the base side, that is, an end effector side is referred to as “distal end side” as well. The up-down direction in FIG. 1 is represented as “vertical direction” and the left-right direction in FIG. 1 is represented as “horizontal direction”.

A robot 100 shown in FIG. 1 is, for example, a robot used for work such as supply, removal, conveyance, and assembly of a precision instrument and components configuring the precision instrument. The robot 100 includes, as shown in FIG. 1, a base 110 functioning as a first member, a first arm 120 functioning as a second member that turns with respect to the base 110, a second arm 130 that turns with respect to the first arm 120, a work head 140, an end effector 150, and a wire drawing-around section 160. The sections of the robot 100 are briefly explained below in order. “Turn” includes moving in both directions including one direction and the opposite direction of the one direction with respect to a certain center point and rotating with respect to the certain center point.

The base 110 is fixed to, for example, a not-shown floor surface by bolts. A control device 190 that collectively controls the robot 100 is set on the inside of the base 110. The first arm 120 is coupled to the base 110 to be capable of turning around a first turning axis J1 along the vertical direction with respect to the base 110.

A first driving section 170 is set in the base 110. The first driving section 170 includes a motor 171, which is a first motor such as a servomotor that generates a driving force for turning the first arm 120, and a gear device 1, which is a first speed reducer that decelerates rotation by a driving force of the motor 171. An input shaft of the gear device 1 is coupled to a rotating shaft of the motor 171. An output shaft of the gear device 1 is coupled to the first arm 120. Accordingly, when the motor 171 is driven and the driving force of the motor 171 is transmitted to the first arm 120 via the gear device 1, the first arm 120 turns in a horizontal plane around the first turning axis J1.

The second arm 130 is coupled to the distal end portion of the first arm 120 to be capable of turning around a second turning axis J2 along the vertical direction with respect to the first arm 120. Although not illustrated, a second driving section is set in the second arm 130. The second driving section has the same configuration as the first driving section 170 and includes a second motor that generates a driving force for turning the second arm 130 and a second speed reducer that decelerates rotation by the driving force of the second motor. The driving force of the second motor is transmitted to the second arm 130 via the second speed reducer, whereby the second arm 130 turns in a horizontal plane around the second turning axis J2 with respect to the first arm 120.

The work head 140 is disposed at the distal end portion of the second arm 130. The work head 140 includes a spline shaft 141 inserted through a not-shown spline nut and a not-shown ball screw nut coaxially disposed at the distal end portion of the second arm 130. The spline shaft 141 is capable of turning around an axis J3 of the spline shaft 141 with respect to the second arm 130 and capable of moving, that is, rising and falling in the up-down direction with respect to the second arm 130.

In the second arm 130, although not illustrated, a rotating motor and a lifting and lowering motor are disposed. A driving force of the rotating motor is transmitted to the spline nut by a not-shown driving-force transmitting mechanism. When the spline nut regularly and reversely rotates, the spline shaft 141 regularly and reversely rotates around the axis J3 along the vertical direction. On the other hand, a driving force of the lifting and lowering motor is transmitted to the ball screw nut by a not-shown driving-force transmitting mechanism. When the ball screw nut regularly and reversely rotates, the spline shaft 141 moves up and down.

The end effector 150 is coupled to the distal end portion, that is, the lower end portion of the spline shaft 141. The end effector 150 is not particularly limited. Examples of the end effector 150 include an end effector that grasps a conveyed object and an end effector that machines a workpiece.

A plurality of wires connected to electronic components, for example, the second motor, the rotating motor, and the lifting and lowering motor disposed in the second arm 130 are drawn around to the inside of the base 110 through the tubular wire drawing-around section 160 that couples the second arm 130 and the base 110. Further, such a plurality of wires are bound in the base 110 to be drawn around to the control device 190 set in the base 110 together with wires connected to the motor 171 and the like.

The robot 100 explained above includes the base 110 functioning as the first member, the first arm 120 functioning as the second member that turns with respect to the base 110, and the gear device 1 that transmits a driving force for turning the first arm 120 with respect to the base 110 from the base 110 to the first arm 120 or from the first arm 120 to the base 110. In this embodiment, power is transmitted from the base 110 side to the first arm 120 side. Consequently, effects of the gear device 1 explained below can be enjoyed. The robot 100 excellent in reliability is obtained.

In this embodiment, the first member is the base 110 and the second member is the first arm 120. However, not only this, but any one of the base 110, the first arm 120, and the second arm 130 may be set as the first member and another one may be set as the second member. Specifically, for example, the first arm 120 may be set as the first member and the second arm 130 may be set as the second member.

### 2. Gear Device

### First Embodiment

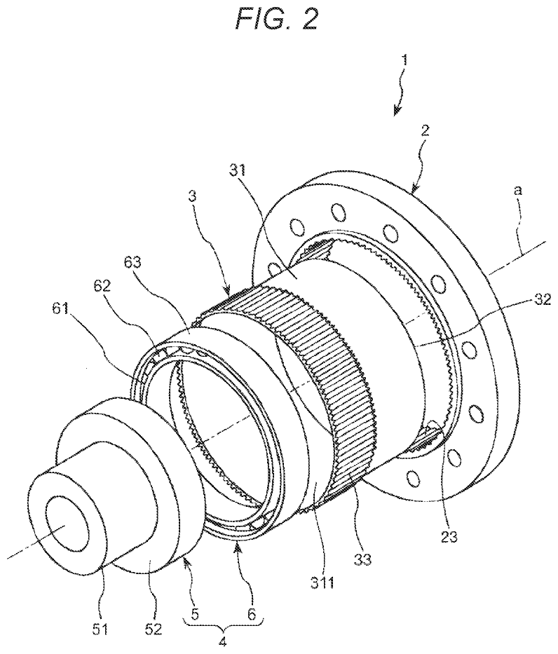

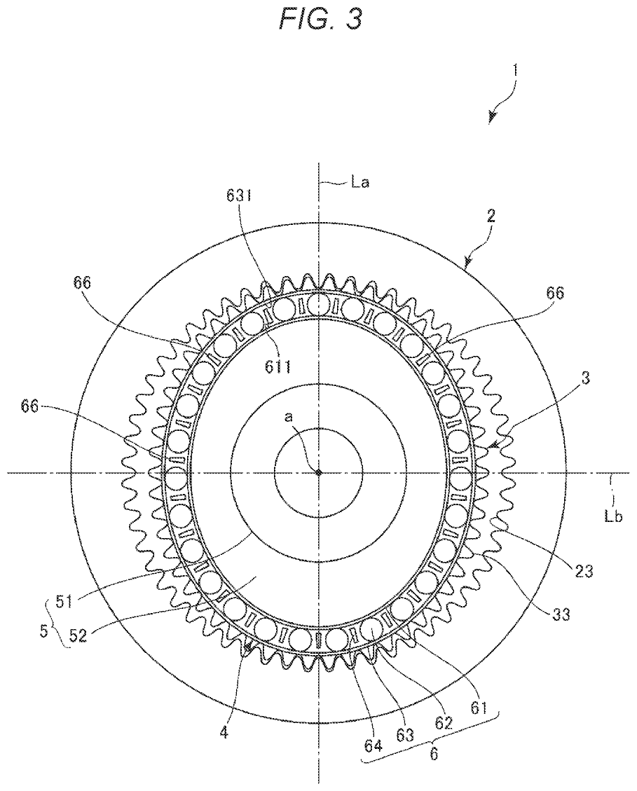

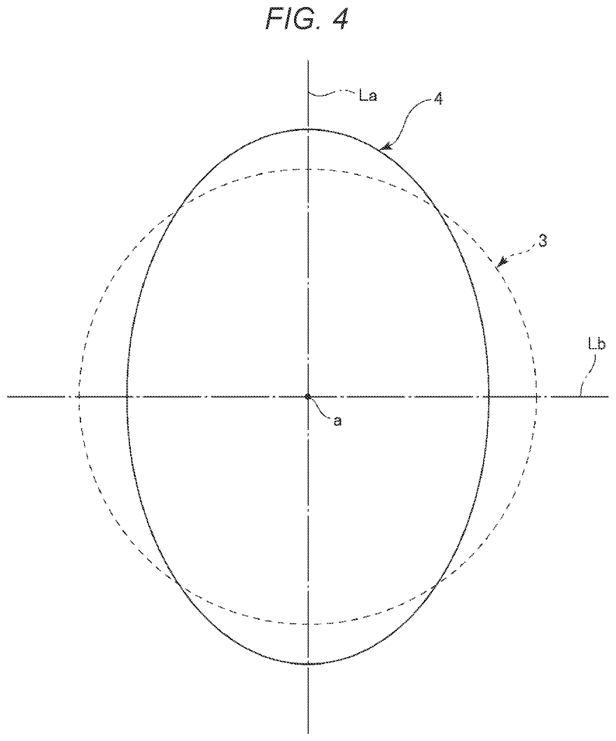

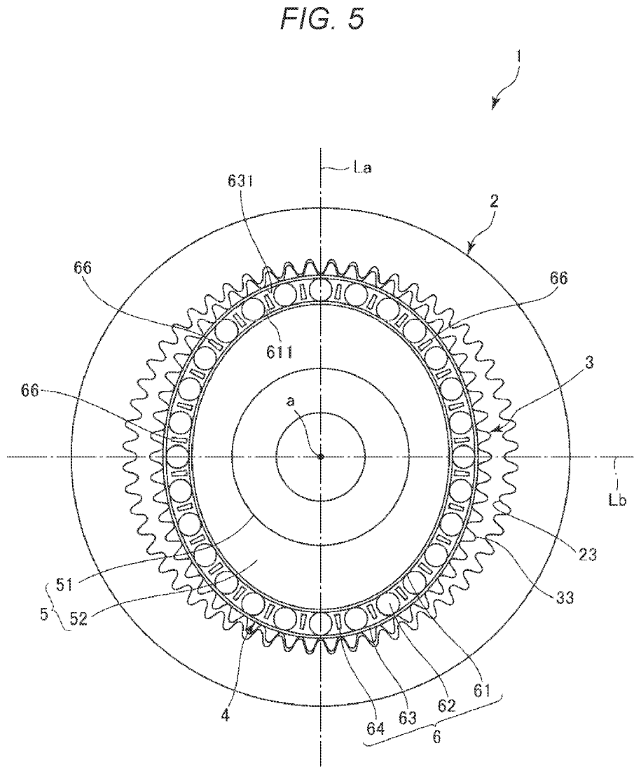

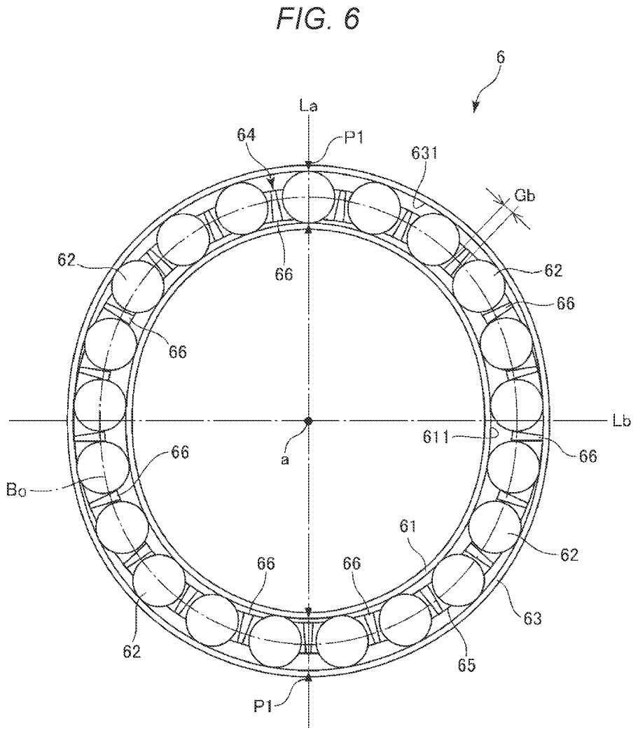

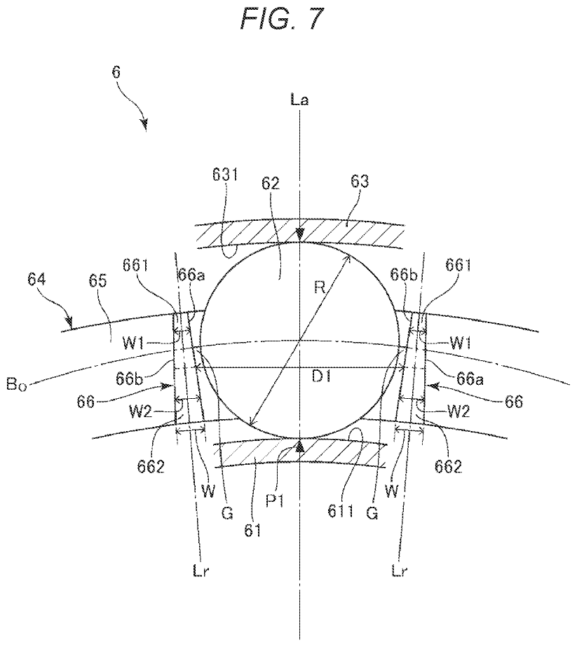

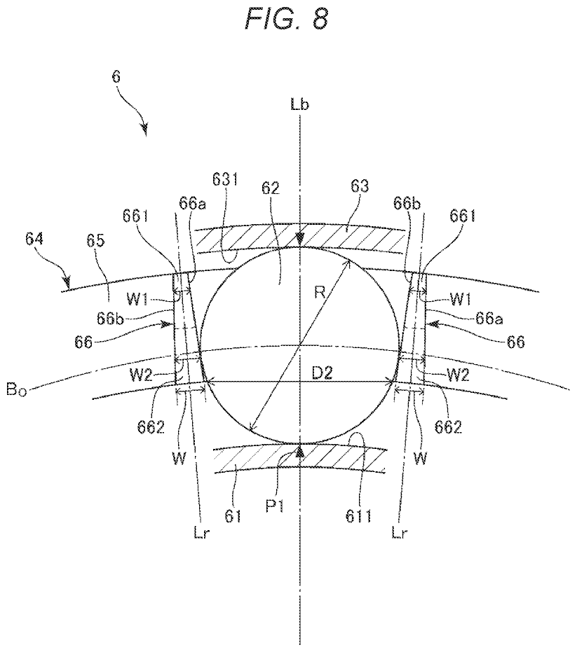

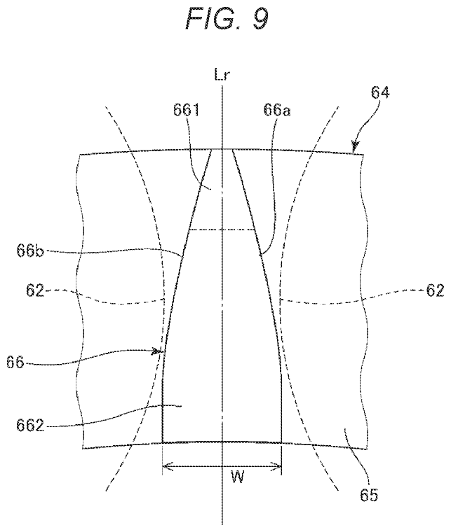

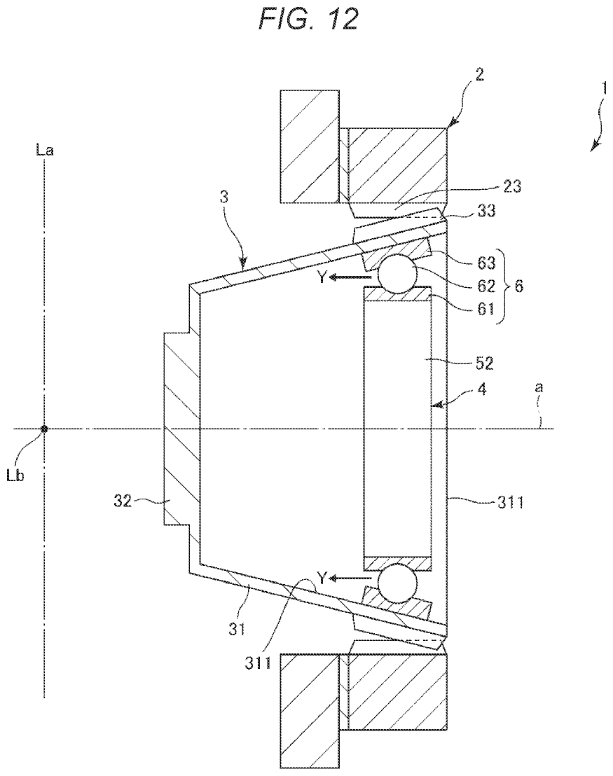

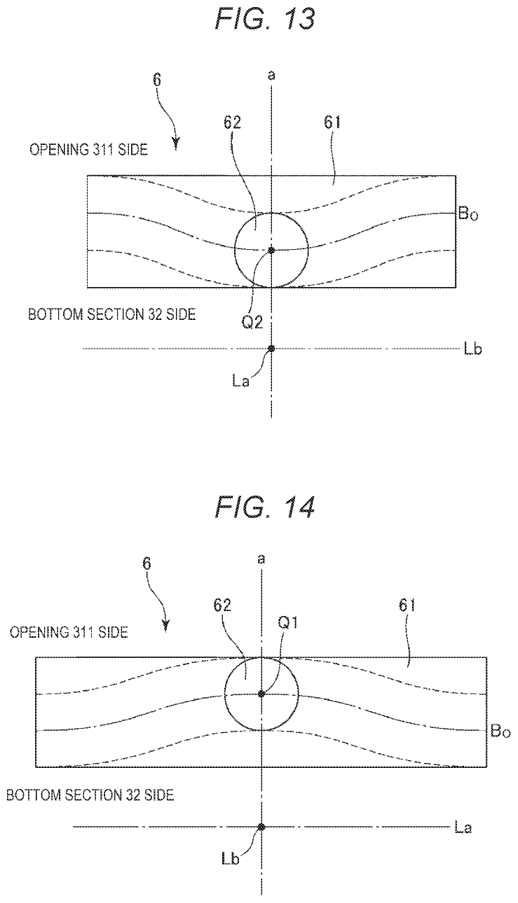

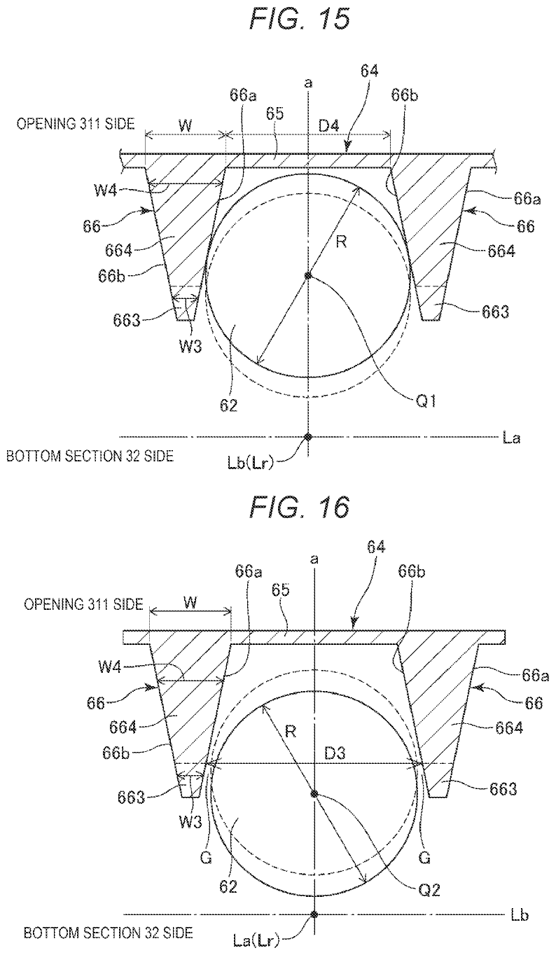

FIG. 2 is an exploded perspective view showing a gear device according to a preferred embodiment of the present disclosure. FIG. 3 is a front view of the gear device shown in FIG. 2. FIG. 4 is a diagram schematically showing states of the outer circumferential surface of a wave motion generator and an inner circumferential surface of an external gear in a natural state in the gear device shown in FIG. 2. FIG. 5 is a front view of the gear device shown in FIG. 2 in which the number of balls of a bearing is set to an even number. FIG. 6 is a front view of the bearing included in the gear device shown in FIG. 2. FIG. 7 is a partially enlarged front view showing a state of the ball located on the major axis of the bearing shown in FIG. 6. FIG. 8 is a partially enlarged front view showing a state of the ball located on the minor axis of the bearing shown in FIG. 6. FIGS. 9 to 11 are partially enlarged front views showing modifications of a partition wall included in the bearing shown in FIG. 6. FIG. 12 is a sectional view schematically showing the gear device shown in FIG. 2. FIGS. 13 and 14 are diagrams showing tracks of the ball included in the bearing. FIGS. 15 and 16 are sectional views from the radial direction of the partition wall included in the gear device shown in FIG. 6. In the figures, for convenience of explanation, dimensions of sections are exaggerated and shown as appropriate according to necessity. Dimension ratios among members do not always coincide with actual dimension ratios.

The gear device 1 shown in FIG. 2 is a wave motion gear device and is used as, for example, a speed reducer. The gear device 1 includes an internal gear 2, a cup-shaped external gear 3 disposed on the inner side of the internal gear 2, a wave motion generator 4 disposed at the inner side of the external gear 3. Although not illustrated, a lubricant such as grease is disposed as appropriate according to necessity in sections of the gear device 1, specifically, a meshing section of the internal gear 2 and the external gear 3, a fitting section of the external gear 3 and the wave motion generator 4, and the like.

One of the internal gear 2, the external gear 3, and the wave motion generator 4 is coupled to the base 110 of the robot 100. Another one is coupled to the first arm 120 of the robot 100. In this embodiment, the internal gear 2 is fixed to the base 110, the external gear 3 is coupled to the first arm 120, and the wave motion generator 4 is coupled to the rotating shaft of the motor 171.

Accordingly, when the rotating shaft of the motor 171 rotates, the wave motion generator 4 rotates at the same rotating speed as the rotating speed of the rotating shaft of the motor 171. Since the internal gear 2 and the external gear 3 have different numbers of teeth each other, the internal gear 2 and the external gear 3 relatively rotate around an axis “a”, which is a rotation axis, because of a difference between the numbers of teeth while a meshing position of the internal gear 2 and the external gear 3 moving in the circumferential direction. In this embodiment, since the number of teeth of the internal gear 2 is larger than the number of teeth of the external gear 3, the external gear 3 can be rotated at rotating speed lower than rotating speed of the rotating shaft of the motor 171. That is, it is possible to realize a speed reducer, an input shaft side of which is the wave motion generator 4 and an output shaft side of which is the external gear 3.

A coupling form of the internal gear 2, the external gear 3, and the wave motion generator 4 is not limited to the form explained above. For example, even if the external gear 3 is fixed to the base 110 and the internal gear 2 is coupled to the first arm 120, the gear device 1 can be used as the speed reducer. Even if the external gear 3 is coupled to the rotating shaft of the motor 171, the gear device 1 can be used as the speed reducer. In this case, all that has to be done is to fix the wave motion generator 4 to the base 110 and couple the internal gear 2 to the first arm 120. When the gear device 1 is used as a speed increaser, that is, when the external gear 3 is rotated at rotating speed higher than the rotating speed of the rotating shaft of the motor 171, the relation between the input side and the output side explained above only has to be reversed.

As shown in FIG. 2, the internal gear 2 is a ring-like rigid gear including internal teeth 23 and formed by a rigid body that substantially does not bend in the radial direction. A fixing method for the internal gear 2 and the base 110 is not particularly limited. Examples of the fixing method include screwing.

The external gear 3 is inserted through the inner side of the internal gear 2. The external gear 3 is a flexible gear including external teeth 33, which mesh with the internal teeth 23 of the internal gear 2, and deflectively deformable in the radial direction. The number of teeth of the external gear 3 is smaller than the number of teeth of the internal gear 2. In this way, the number of teeth of the external gear 3 and the number of teeth of the internal gear 2 are different from each other. Consequently, as explained above, the speed reducer can be realized by the gear device 1.

In this embodiment, the external gear 3 is formed in a cup shape. The external teeth 33 are formed on the outer circumferential surface of the external gear 3. The external gear 3 includes a bottomed cylindrical body section 31 including an opening 311 at one end portion thereof and a bottom section 32 projecting from the other end portion of the body section 31. The body section 31 includes, centering on the axis “a”, the external teeth 33 that mesh with the internal gear 2. A shaft body on the output side, for example, the rotating shaft of the motor 171 is attached to the bottom section 32 by screwing or the like.

As shown in FIG. 3, the wave motion generator 4 is disposed at the inner side of the external gear 3 and capable of rotating around the axis “a”. As shown in FIG. 4, the wave motion generator 4 deforms a cross section of the body section 31 of the external gear 3, which is circular in a natural state, into an elliptical shape or an oval shape having a major axis La and a minor axis Lb and partially meshes a part of the external teeth 33, specifically, both sides of the major axis La with a part of the internal teeth 23 of the internal gear 2.

As shown in FIG. 3, the wave motion generator 4 includes a cam 5 and a bearing 6 attached to the outer circumference of the cam 5 and sandwiched between the cam 5 and the external gear 3. The cam 5 includes a shaft section rotating around the axis “a” and a cam section 52 projecting to the outer side from one end portion of the shaft section 51. The cam section 52 is formed in a longitudinal shape when viewed from a direction along the axis “a”, in particular, in this embodiment, an elliptical shape or an oval shape having the up-down direction in FIG. 3 as the major axis La. However, the shape of the cam section 52 is not particularly limited if the shape is the longitudinal shape.

As shown in FIG. 3, the bearing 6 is a ball bearing and includes a flexible inner ring 61 and a flexible outer ring 63, a plurality of balls 62 disposed between the inner ring 61 and the outer ring 63, and a holder 64 holding the plurality of balls 62 to keep an interval in the circumferential direction constant. In a natural state, the bearing 6 is formed in a circular shape when viewed from the direction along the axis “a”. The cam section 52 is fit on the inner side of the bearing 6, whereby the bearing 6 is deformed into a longitudinal shape, in this embodiment, an elliptical shape or an oval shape along the outer circumferential surface of the cam section 52.

The inner ring 61 is fit in the outer circumferential surface of the cam section 52 of the cam 5 and deformed into an elliptical shape or an oval shape along the outer circumferential surface of the cam section 52. According to the deformation, the outer ring 63 is also deformed into an elliptical shape or an oval shape. The outer circumferential surface of the inner ring 61 and the inner circumferential surface of the outer ring 63 are respectively formed as track surfaces 611 and 631 that roll the plurality of balls 62 while guiding the plurality of balls 62 along the circumferential surface.

Since FIG. 3 is a diagram for briefly explaining an overall configuration of the bearing 6, for convenience of explanation, the configuration of the bearing 6, in particular, the configuration of the holder 64 is simplified and shown. The holder 64 is separately explained in detail with reference to FIGS. 6 to 8.

In such a wave motion generator 4, the direction of the cam section 52 changes according to rotation of the cam 5 around the axis “a”. According to the change of the direction of the cam section 52, the outer ring 63 is deformed to move the mutual meshing position of the internal gear 2 and the external gear 3 in the circumferential direction. Since the inner ring 61 is fixedly set with respect to the outer circumferential surface of the cam section 52, a deformed state of the inner ring 61 does not change. The mutual meshing position of the internal gear 2 and the external gear 3 moves in the circumferential direction, whereby the internal gear 2 and the external gear relatively rotate around the axis “a” because of the number of teeth difference between the internal gear 2 and the external gear 3. That is, the first arm 120, to which the external gear 3 is fixed, turns around the axis “a” with respect to the base 110 to which the internal gear 2 is fixed.

The plurality of balls 62 are disposed between the inner ring 61 and the outer ring 63. The plurality of balls 62 are held to be disposed side by side at substantially equal intervals in the circumferential direction of the bearing 6 by the holder 64. Consequently, variation of the interval between a pair of balls 62 adjacent to each other is suppressed. Deterioration in characteristics of the bearing 6 can be suppressed. The number of the balls 62 is an odd number. However, not only this, but the number of the balls 62 may be an even number.

When it is assumed that the plurality of balls 62 are disposed at equal intervals and the number of the balls 62 is set to an even number, as shown in FIG. 5, there is timing when the balls 62 are aligned at both sides of the major axis La. When the balls 62 are aligned at both the sides of the major axis La, the bearing 6 stiffens between the cam 5 and the external gear 3 in the major axis La direction. A compression force from the cam 5 is transmitted to the external gear 3 without being reduced by the bearing 6. Therefore, for example, depending on strength and design accuracy of the sections of the gear device 1, it is likely that the internal gear 2 and the external gear 3 excessively strongly mesh with each other and slidability is deteriorated and the gear device 1 is broken.

On the other hand, when it is assumed that the plurality of balls 62 are disposed at equal intervals and the number of the balls 62 is set to an odd number, as shown in FIG. 3, there is no timing when the balls 62 are aligned on both the sides of the major axis La. That is, at certain timing, when the ball 62 is located at one side of the major axis La, the ball 62 is not located at the other side. Consequently, the “stiffening” that occurs when the number of the balls 62 is an even number does not occur. The compression force from the cam 5 is reduced by the bearing 6 and transmitted to the external gear 3. Therefore, it is possible to effectively suppress the deterioration in the slidability of the internal gear 2 and the external gear 3 and the breakage of the gear device 1 that could occur when the number of the balls 62 is an even number.

The bearing 6 into which the cam section 52 is fit is shown in FIG. 6. In FIG. 6, illustration of the cam section 52 is omitted. As shown in FIG. 6, the holder 64 includes a ring-like base 65 and a plurality of partition walls 66 projecting between the inner ring 61 and the outer ring 63 from the base 65. The base 65 has a circular shape in a natural state. Even if the bearing 6 is fit in the cam 5, the base 65 substantially does not receive a compression force from the cam 5 and maintains the circular shape without being deformed.

The plurality of partition walls 66 are disposed at equal intervals along the circumferential direction of the base 65. The plurality of partition walls 66 are disposed such that one ball 62 is located between a pair of partition walls 66 adjacent to each other. That is, in the bearing 6, the balls 62 and the partition walls 66 are alternately disposed side by side along the circumferential direction of the bearing 6. In this way, one ball 62 is disposed between the pair of partition walls 66. Consequently, the plurality of balls 62 can be disposed at equal intervals. In a natural state before the inner ring 61 and the outer ring 63 are deformed into an elliptical shape or an oval shape, the ball 62 is loosely held between a pair of partition walls 66 located at both sides of the ball 62 in the circumferential direction. The ball 62 is allowed to slightly move in a center track Bo direction of the ball 62. Consequently, it is possible to reduce a frictional force applied to the ball 62 while holding the ball 62. Accordingly, it is possible to make it easy to move the ball 62 while restricting displacement to the center track Bo of the ball 62.

As explained above, the cam section 52 is fit in the bearing 6, whereby the inner ring 61 and the outer ring 63 are deformed from the circular shape into the elliptical shape or the oval shape. On the other hand, the base 65 maintains the circular shape. Accordingly, when viewed from the direction along the axis “a”, on the major axis La, the partition wall 66 is located to deviate to the inner ring 61 side with respect to the center track Bo of the ball 62. Conversely, on the minor axis Lb, the partition wall 66 is located to deviate to the outer ring 63 side with respect to the center track Bo.

In the bearing 6, making use of such a difference between the position on the major axis La and the position on the minor axis Lb of the partition wall 66, as shown in FIG. 7, the ball 62 located on the major axis La is held by the holder 64 in a state in which a gap G is present between the ball 62 and a pair of partition walls 66 located on both sides of the ball 62. As shown in FIG. 8, the ball 62 located on the minor axis Lb is held by the holder 64 in a state in which the ball 62 is in contact with each of a pair of partition walls 66 located on both sides of the ball 62, that is, a state in which the gap G is absent. In other words, the ball 62 located on the major axis La is held without being sandwiched between the pair of partition walls 66 located on both sides of the ball 62. Conversely, the ball 62 located on the minor axis Lb is held in a state in which the ball 62 is sandwiched between the pair of partition walls 66 located on both sides of the ball 62.

As explained in “Background” above, on the major axis La, the interval between the inner ring 61 and the outer ring 63 is narrowed and the ball 62 is sandwiched between the inner ring 61 and the outer ring 63, whereby a compression force P1 in the radial direction is applied to the ball 62. Accordingly, on the major axis La, the ball 62 less easily moves. The ball 62 is less easily displaced in the direction of the center track Bo between the pair of partition walls 66 adjacent to each other. Consequently, on the major axis La, an interval Gb between the balls 62 less easily changes. On the other hand, on the minor axis Lb, a compression force P2 in the radial direction smaller than the compression force P1 is applied to the ball 62. Accordingly, on the minor axis Lb, the ball 62 more easily moves than on the major axis La. The ball 62 is easily displaced to the direction of the center track Bo between the pair of partition walls 66 adjacent to each other. Consequently, on the minor axis Lb, the interval Gb between the balls 62 easily changes.

In this way, the bearing 6 deformed from the circular shape into the elliptical shape or the oval shape has a characteristic that the interval Gb easily deviates on the minor axis Lb and less easily deviates on the major axis La. Accordingly, it is likely that the interval Gb deviates on the minor axis Lb and the deviating inappropriate interval Gb is maintained on the major axis La. When the inappropriate interval Gb is maintained in this way, for example, the “stiffening”, which does not occur in an ideal state, occurs. It is more highly likely that an unintended excessive compression force is applied to the gear device 1. Accordingly, it is more highly likely that performance deterioration of and damage to the gear device 1 are caused.

Therefore, in this embodiment, the ball 62 on the minor axis Lb is sandwiched between the pair of partition walls 66 located on both sides of the balls 62 and displacement in a direction along the center track Bo of the ball 62 is restricted. Consequently, it is possible to effectively suppress deviation of the interval Gb on the minor axis Lb. The appropriate interval Gb is maintained on the major axis La as well. Accordingly, the plurality of balls 62 are disposed at equal intervals in the entire circumference of the center track Bo. It is possible to effectively suppress occurrence of the “stiffening”. As a result, it is possible to effectively suppress performance deterioration of and damage to the gear device 1. On the other hand, on the major axis La on which displacement in the direction along the center track Bo of the ball 62 less easily occurs because the compression force P1 is applied to the ball 62, the interval Gb is maintained even if the ball 62 is not sandwiched between the pair of partition walls 66. Accordingly, since the ball 62 is not sandwiched between the pair of partition walls 66 located on both sides of the ball 62, the ball 62 is suppressed from much less easily moving. Consequently, it is possible to suppress an excessive frictional force from occurring in the ball 62. It is possible to suppress excessive wear of the sections of the bearing 6 and characteristic deterioration and a failure due to the wear.

Among the plurality of balls 62 included in the bearing 6, when at least one ball 62 is located on the major axis La, the ball 62 only has to be held by the holder 64 in a state in which the gap G is present between the ball 62 and a pair of partition walls 66 located on both sides of the ball 62. However, it is preferable that the balls 62 equal to or more than 80% of the number of all the balls are held by the holder 64 in the state, it is more preferable that the balls 62 equal to or more than 90% of the number of all the balls 62 are held by the holder 64 in the state, and it is most preferable that all the balls 62 are held by the holder 64 in the state. Similarly, when at least one ball 62 among the plurality of balls 62 included in the bearing 6 is located on the minor axis Lb, the ball 62 only has to be held by the holder 64 in a state in which the ball 62 is in contact with each of a pair of partition walls 66 located on both sides of the ball 62. However, it is preferable that the balls 62 equal to or more than 80% of the number of all the balls 62 are held by the holder 64 in the state, it is more preferable that the balls 62 equal to or more than 90% of the number of all the balls 62 are held by the holder 64 in the state, and it is most preferable that all the balls 62 are held by the holder 64 in the state.

The configuration of the partition wall 66 for realizing the action explained above is explained. Since the plurality of partition walls 66 have the same configuration, in the following explanation, one partition wall 66 is representatively explained. Explanation of the other partition walls 66 is omitted.

First, a plan view shape of the partition wall 66, that is, a shape of the partition wall 66 viewed from a direction along the axis “a” is explained. As shown in FIGS. and 8, the partition wall 66 extends along a radial direction Lr of the bearing 6. The partition wall 66 includes a distal end portion 661 functioning as a first portion and a proximal end portion 662 functioning as a second portion disposed side by side in the radial direction Lr when viewed from the direction along the axis “a”. The proximal end portion 662 is located further at the inner side of the radial direction Lr, that is, the axis “a” side than the distal end portion 661. As shown in FIG. 7, the ball 62 on the major axis La is generally opposed to the distal end portion 661 located on the outer circumference side of the base 65. On the other hand, as shown in FIG. 8, the ball 62 on the minor axis Lb is generally opposed to the proximal end portion 662 located on the inner circumference side of the base 65. In other words, a portion passing the center track Bo of the ball 62 on the major axis La is located between a pair of distal end portions 661 adjacent to each other. A portion passing the center track Bo of the ball 62 on the minor axis Lb is located between a pair of proximal end portions 662 adjacent to each other.

When viewed from the direction along the axis “a”, width W2 in a direction orthogonal to the radial direction Lr of the proximal end portion 662 is larger than width W1 in the direction orthogonal to the radial direction Lr of the distal end portion 661. That is, W2>W1. “The direction orthogonal to the radial direction Lr” is considered to be the circumferential direction of the bearing 6 as well. As shown in FIG. 7, a minimum separation distance D1 between the pair of distal end portions 661 adjacent to each other is larger than a diameter R of the ball 62. As shown in FIG. 8, a minimum separation distance D2 between the pair of proximal end portions 662 adjacent to each other is smaller than the diameter R of the ball 62. That is, D2<R<D1. Consequently, the ball 62 on the major axis La is not sandwiched between the pair of partition walls 66 located on both sides of the ball 62. The gap G is provided between the ball 62 and the pair of partition walls 66. On the other hand, the ball 62 on the minor axis Lb is sandwiched between a pair of partition walls 66 located on both sides of the ball 62. With such partition walls 66, it is possible to more surely realize the action explained above.

In the partition wall 66 in this embodiment, when viewed from the direction along the axis “a”, the width W in the direction orthogonal to the radial direction Lr gradually decreases toward the outer side of the radial direction Lr. In particular, a gradual decrease rate of the width W is fixed along the radial direction Lr. Accordingly, when viewed from the direction along the axis “a”, the partition wall 66 is formed in a wedge shape or a trapezoidal shape tapered toward the outer side of the radial direction Lr. The partition wall 66 includes a side surface 66a opposed to the ball 62 located at one side of the partition wall 66 and a side surface 66b opposed to the ball 62 located at the other side. The side surfaces 66a and 66b are flat surfaces when viewed from the direction along the axis “a”. Consequently, the shape of the partition wall 66 is simplified.

However, the shape of the side surfaces 66a and 66b are not limited to this. For example, as shown in FIG. 9, the gradual decrease rate of the width W may gradually increase toward the outer side of the radial direction Lr. When viewed from the direction along the axis “a”, the side surfaces 66a and 66b may be formed as convex curved surfaces projecting to the ball 62 sides opposed to the side surfaces 66a and 66b. With such a configuration, for example, the ball 62 can be designed to be sandwiched between the pair of partition walls 66 in a relatively early stage, that is, a region close to the major axis La when the ball 62 moves from the major axis La to the minor axis Lb compared with this embodiment. Accordingly, a time in which the ball 62 is sandwiched between the pair of partition walls 66 increases. Specifically, when the cam section 52 rotates once with respect to a predetermined ball 62, a ratio of a time in which the ball 62 is sandwiched between the pair of partition walls 66 to a time required for one rotation increases. Therefore, it is possible to more effectively suppress deviation of a gap Gb between the balls 62.

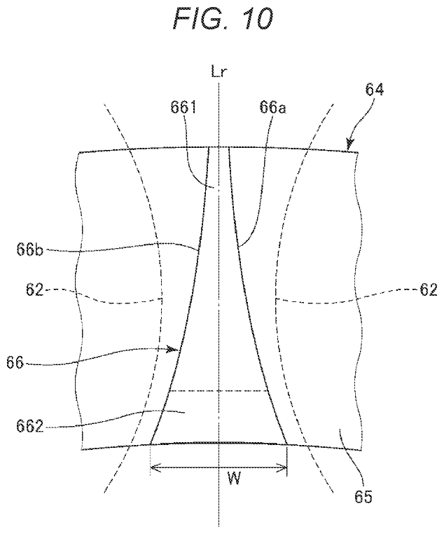

For example, as shown in FIG. 10, the gradual decrease rate of the width W may gradually decrease toward the outer side of the radial direction Lr. When viewed from a direction along the axis “a”, the side surfaces 66a and 66b may be formed as concave curved surfaces recessed to the inner side. With such a configuration, for example, the ball 62 can be designed to be sandwiched between the pair of partition walls 66 in a relatively late stage, that is, a region close to the minor axis Lb when the ball 62 moves from the major axis La to the minor axis Lb compared with this embodiment. Accordingly, a time in which the ball 62 is not sandwiched between the pair of partition walls 66 increases. Therefore, it is possible to effectively reduce frictional resistance of the ball 62.

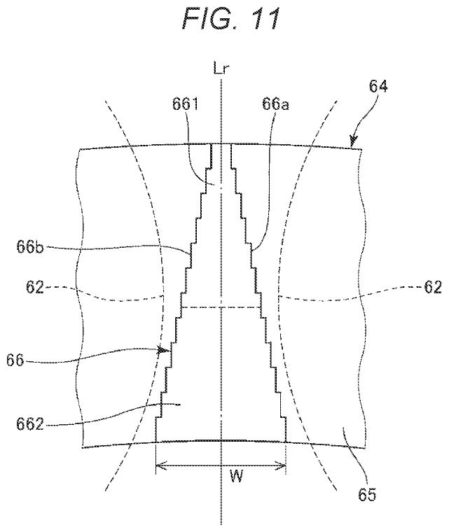

For example, as shown in FIG. 11, the side surfaces 66a and 66b may be formed as step surfaces including at least one step, in the configuration shown in FIG. 11, a plurality of steps.

A track of the ball 62 at the time when viewed from the radial direction Lr, that is, the direction orthogonal to the axis “a” is focused. As shown in FIG. 12, at both sides of the major axis La, the outer ring 63 is displaced to the bottom section 32 side with respect to the inner ring 61 because the body section 31 of the external gear 3 is deformed in a taper shape widening to the opening 311 side of the body section 31. Accordingly, according to the displacement, the ball 62 is also displaced to the bottom section 32 side as indicated by an arrow Y. On the other hand, although not illustrated, at both sides of the minor axis Lb, the outer ring 63 is displaced to the opening 311 side with respect to the inner ring 61 because the body section 31 of the external gear 3 is deformed in a reverse taper shape narrowing to the opening 311 side. Accordingly, the ball 62 is also displaced to the opening 311 side according to the displacement. Therefore, as shown in FIGS. 13 and 14, the center track Bo of the ball 62 becomes the center track Bo having a substantially sine wave shape to be at a top point Q1 located at the opening 311 side most on the minor axis Lb and to be at a bottom point Q2 located on the bottom section 32 side most on the major axis La.

As shown in FIGS. 15 and 16, the partition wall 66 includes a lower end portion 663 and an upper end portion 664 disposed side by side in the direction along the axis “a” when viewed from a direction along the radial direction Lr. The upper end portion 664 is located further at the opening 311 side than the lower end portion 663. As shown in FIG. 15, the ball 62 on the minor axis Lb located at the top point Q1 is opposed to the upper end portion 664. On the other hand, as shown in FIG. 16, the ball 62 on the major axis La located at the bottom point Q2 is opposed to the lower end portion 663. In other words, the ball 62 on the minor axis Lb is located between a pair of upper end portions 664 adjacent to each other. The ball 62 on the major axis La is located between a pair of bottom end portions 663 adjacent to each other.

When viewed from the direction along the radial direction Lr, width W3 of the lower end portion 663 is smaller than width W4 of the upper end portion 664. That is, W3<W4. A minimum separation distance D3 between the pair of lower end portions 663 adjacent to each other is larger than the diameter R of the ball 62. A minimum separation distance D4 between the pair of upper end portions 664 adjacent to each other is smaller than the diameter R of the ball 62. That is, D4<R<D3. Consequently, the ball 62 on the major axis La is not sandwiched between a pair of partition walls 66 located on both sides of the ball 62 and is held by the holder 64 in a state in which the gap G is provided between the ball 62 and the pair of partition walls 66. On the other hand, the ball 62 on the minor axis Lb is sandwiched between a pair of partition walls 66 located on both sides of the ball 62 and is held by the holder 64 in a state in which the ball 62 is in contact with each of the pair of partition walls 66, that is, a state in which the gap G is not provided between the ball 62 and the pair of partition walls 66.

In the partition wall 66 in this embodiment, when viewed from the direction along the radial direction Lr, the width W gradually increases toward the opening 311 side from the bottom section 32 side. In particular, a gradual decrease rate of the width W is fixed along the axis “a”. Therefore, when viewed from the direction along the radial direction Lr, the partition wall 66 is formed in a wedge shape or a trapezoidal shape tapered from the opening 311 side toward the bottom section 32 side. Side surfaces 66a and 66b are respectively flat surfaces when viewed from the direction along the radial direction Lr. Consequently, the shape of the partition wall 66 is simplified.

However, the shape of the side surfaces 66a and 66b is not limited to this. For example, as in the plan view shape shown in FIG. 9, the gradual decrease rate of the width W may gradually increase from the opening 311 side toward the bottom section 32 side. When viewed from the direction along the radial direction Lr, the side surfaces 66a and 66b may be formed as convex curved surfaces projecting to the ball 62 side opposed to the side surfaces 66a and 66b. With such a configuration, for example, the ball 62 can be designed to be sandwiched between the pair of partition walls 66 in a relatively early stage, that is, a region close to the major axis La when the ball 62 moves from the major axis La to the minor axis Lb compared with this embodiment. Accordingly, a time in which the ball 62 is sandwiched between the pair of partition walls 66 increases. Therefore, it is possible to more effectively suppress deviation of the interval Gb between the balls 62.

For example, as in the plan view shape shown in FIG. 10, the gradual decrease rate of the width W may gradually decrease from the opening 311 side toward the bottom section 32 side. When viewed from the direction along the radial direction Lr, the side surfaces 66a and 66b may be formed as concave curved surfaces recessed to the inner side. With such a configuration, for example, the ball 62 can be designed to be sandwiched between the pair of partition walls 66 in a relatively late stage, that is, a region close to the minor axis Lb when the ball 62 moves from the major axis La to the minor axis Lb compared with this embodiment. Accordingly, a time in which the ball 62 is not sandwiched between the pair of partition walls 66 increases. Therefore, it is possible to more effectively reduce frictional resistance of the ball 62.

For example, as in the plan view shape shown in FIG. 11, the side surfaces 66a and 66b may be formed as step surfaces including at least one step, in the illustrated configuration, a plurality of steps.

The gear device 1 is explained above. Such a gear device 1 includes, as explained above, the internal gear 2, the external gear 3 having flexibility that partially meshes with the internal gear 2 and relatively rotates around the axis “a”, which is the rotation axis, with respect to the internal gear 2, the bearing 6 disposed at the inner side of the external gear 3, and the elliptical cam section 52 that is disposed at the inner side of the bearing 6 and moves the meshing position of the internal gear 2 and the external gear 3 in the circumferential direction around the axis “a”. The bearing 6 includes the plurality of balls 62 deformed into an elliptical shape by the cam section 52 and disposed side by side in the circumferential direction, and the holder 64 including the plurality of partition walls 66 disposed alternately with the balls 62 in the circumferential direction and holding the balls 62. The gap G is provided between the ball 62 located on the major axis La of the bearing 6 and the partition wall 66 adjacent to the ball 62 in the circumferential direction. The ball located on the minor axis Lb of the bearing 6 is in contact with each of the partition walls 66 adjacent to the ball 62 on both the sides in the circumferential direction. Consequently, a rotational motion is performed by the bearing 6 in which the interval between the balls 62 adjacent to each other is properly kept. As a result, it is possible to suppress performance deterioration of and damage to the gear device 1.

As explained above, the partition wall 66 includes the distal end portion 661, which is the first portion adjacent to the ball 62 located on the major axis La in the circumferential direction, and the proximal end portion 662, which is the second portion located further on the axis “a” side than the distal end portion 661 and adjacent to the ball 62 located on the minor axis Lb in the circumferential direction. The width W2 in the circumferential direction of the proximal end portion 662 is larger than the width W1 in the circumferential direction of the distal end portion 661. Consequently, the ball 62 located on the major axis La of the bearing 6 is more surely held by the holder 64 in the state in which the gap G is provided between the ball 62 and the pair of partition walls 66 located on both the sides of the ball 62. The ball 62 located on the minor axis Lb of the bearing 6 is more surely held by the holder 64 in the state in which the ball 62 is in contact with each of the pair of partition walls 66 located on both sides of the ball 62.

As explained above, the width W in the circumferential direction of the partition wall 66 gradually decreases toward the direction away from the axis “a”. Consequently, the shape of the partition wall 66 is simplified.

As explained above, when viewed from the direction along the axis “a”, the side surfaces 66a and 66b of the partition wall 66 opposed to the ball 62 are the flat surfaces. Consequently, the shape of the partition wall 66 is simplified.

As explained above, when viewed from the direction along the axis “a”, the side surfaces 66a and 66b of the partition wall 66 opposed to the ball 62 may be convex surfaces projecting to the ball 62 side. Consequently, the ball 62 can be designed to be sandwiched by the pair of partition walls 66 in a relatively early stage when the ball 62 moves from the major axis La to the minor axis Lb compared with when the side surfaces 66a and 66b are the flat surfaces. Accordingly, a time in which the ball 62 is sandwiched between the pair of partition walls 66 increases. Therefore, it is possible to more effectively suppress the deviation of the interval Gb between the balls 62.

As explained above, the number of balls 62 is an odd number. Consequently, the “stiffening” less easily occurs. It is possible to suppress performance deterioration of and damage to the gear device 1.

### Second Embodiment

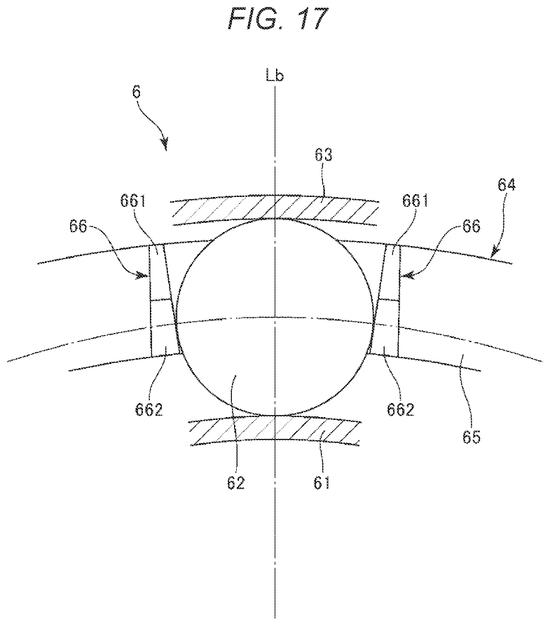

FIG. 17 is a partially enlarged front view showing a bearing included in a gear device according to a second embodiment.

The gear device 1 according to this embodiment is the same as the gear device 1 in the first embodiment except that the configuration of the partition wall 66 is different. In the following explanation, concerning the gear device 1 in the second embodiment, differences from the first embodiment are mainly explained. Explanation about similarities to the first embodiment is omitted. In FIG. 17, the same components as the components in the first embodiment are denoted by the same reference numerals and signs. Since the partition walls 66 have the same configuration, one partition wall 66 is representatively explained below.

As shown in FIG. 17, in the partition wall 66 in this embodiment, the distal end portion 661 and the proximal end portion 662 are configured by separate bodies. Constituent materials of the distal end portion 661 and the proximal end portion 662 are different from each other. Specifically, a Young's modulus E2 of the proximal end portion 662 is lower than a Young's modulus E1 of the distal end portion 661. That is, E2<E1. Consequently, the proximal end portion 662 is softer than the distal end portion 661. Since the proximal end portion 662 is a portion in contact with the ball 62 present on the minor axis Lb, by softening the proximal end portion 662, it is possible to effectively suppress breakage and wear of the ball 62 due to the contact with the partition wall 66. As the Young's moduli E1 and E2, E1/E2≥2 [GPa] or more is preferable, E1/E2≥5 [GPa] or more preferable, and E1/E2≥10 [GPa] or more is still more preferable. Consequently, the proximal end portion 662 can be sufficiently softened. The Young's modulus E2 is not particularly limited. Depending on the constituent material of the ball 62, for example, the Young's modulus E2 is preferably lower than a Young's modulus E3 of the ball 62. That is, E2<E3 is preferable. Consequently, the proximal end portion 662 is softer than the ball 62. It is possible to more conspicuously exert the effects explained above.

As explained above, in the gear device 1 in this embodiment, the Young's modulus E2 of the proximal end portion 662 is lower than the Young's modulus E1 of the distal end portion 661. Consequently, the proximal end portion 662 can be softened. It is possible to effectively suppress breakage and wear of the ball 62 due to the contact with the partition wall 66.

According to such a second embodiment, it is possible to exert the same effects as the effects in the first embodiment.

The gear device and the robot according to the present disclosure are explained above based on the embodiments shown in the figures. However, the present disclosure is not limited to the embodiments. The components of the sections can be replaced with any components having the same functions. Any other components may be added to the present disclosure.

In the embodiments, a horizontal articulated robot is explained. However, the robot according to the present disclosure is not limited to the horizontal articulated robot. For example, the number of joints of a robot is optional. The present disclosure can also be applicable to a vertical articulated robot.

In the embodiments, as an example, the external gear included in the gear device is formed in the cup shape (the bottomed cylindrical shape). However, the external gear is not limited to the cup shape. For example, the external gear may be formed in a hat shape (a cylindrical shape with a brim). When the external gear is formed in the hat shape, the external gear includes, as an attachment section, a flange section extending from the other end portion of the body section to the radial direction outer side.

What is claimed is:

1. A gear device comprising:
an internal gear;
an external gear having flexibility configured to partially mesh with the internal gear and relatively rotate around a rotation axis with respect to the internal gear;
a bearing disposed at an inner side of the external gear; and
a cam section having an elliptical shape disposed at an inner side of the bearing and configured to move a meshing position of the internal gear and the external gear in a circumferential direction around the rotation axis, wherein
the bearing is deformed in an elliptical shape by the cam section and includes:
a plurality of balls disposed side by side in the circumferential direction; and
a holder including a plurality of partition walls disposed alternately with the balls in the circumferential direction and holding the balls,
a gap is provided between the ball located on a major axis of the bearing and the partition wall adjacent to the ball in the circumferential direction, and
the ball located on a minor axis of the bearing is in contact with each of the partition walls adjacent to the ball at both sides in the circumferential direction.

2. The gear device according to claim 1, wherein
the partition wall includes:
a first portion adjacent to the ball located on the major axis in the circumferential direction; and
a second portion located further at the rotation axis side than the first portion and adjacent to the ball located on the minor axis in the circumferential direction, and
width in the circumferential direction of the second portion is larger than width in the circumferential direction of the first portion.

3. The gear device according to claim 2, wherein width in the circumferential direction of the partition wall gradually decreases toward a direction away from the rotation axis.

4. The gear device according to claim 3, wherein a side surface opposed to the ball of the partition wall is a flat surface when viewed from a direction along the rotation axis.

5. The gear device according to claim 3, wherein a side surface opposed to the ball of the partition wall is a convex surface projecting to the ball side when viewed from a direction along the rotation axis.

6. The gear device according to claim 2, wherein a Young's modulus of the second portion is lower than a Young's modulus of the first portion.

7. The gear device according to claim 1, wherein a number of the balls is an odd number.

8. A robot comprising:
a first member;
a second member configured to turn with respect to the first member; and
the gear device according to claim 1 configured to transmit a driving force for turning the second member with respect to the first member from the first member to the second member or from the second member to the first member.
